(19) United States
(12) Patent Application Publication
(10) Pub. No.: US 2010/0111343 A1
(43) Pub. Date: May 6, 2010

(54) Display with miniature speaker and the structure of the miniature speaker

(75) Inventor: Wei Hsu, Chung Ho City (TW)

Correspondence Address: BACON & THOMAS, PLLC, 625 SLATERS LANE, FOURTH FLOOR, ALEXANDRIA, VA, 22314-1176, US

(73) Assignee: Weistech Technology Co., LTD., Chung Ho City (TW)

(21) Appl. No.: 12/289,648

(22) Filed: Oct. 31, 2008

(51) Int. Cl. H04R 1/02; G09G 3/36

(52) U.S. Cl. 381/335; 345/87

(57) ABSTRACT

The present invention discloses to display with a miniature speaker and the structure of the speaker. The speaker includes a speaker unit and a plurality of passive radiators. The enclosure of the speaker has a first passive radiator mounted on the front side thereof and a second passive radiator mounted on the back side so that increases the damping effect within the enclosure to improve the bass performance.

### FIELD OF THE INVENTION

This invention is generally directed to the field of an enclosure of a speaker, more particularly, to a structure of a sealed type miniature speaker.

### DESCRIPTION OF THE PRIOR ART

The speaker or loudspeaker contains an enclosure to compress the fluid of air, and it is the mechanical structure using of damping mediums. The speaker or loudspeaker unit is a complex unit combining mass phenomenon, elastic action, and damping effect. When the speaker unit vibrates, it generates sound waves by the elastic vibration of its suspension system. Because the air in the enclosure weighs, if we place the speaker unit within the enclosure, the air will progress within the enclosure as it is in pressure waves when the speaker unit generates sound pressure and compress the air in the enclosure.

The Taiwan patent M326304 discloses a one cabinet 2.1 channel enclosure which comprises enclosure front panel, bass output line, enclosure top cover, enclosure bottom cover, derived built-in left/right channel enclosure from top/bottom cover or outer left/right channel enclosure, enclosure back panel, bass speaker, left/right channel speaker, and power amplifier circuit board. The above skill takes the built-in left/right enclosure mechanism and integrates the three cabinet 2.1 channel enclosure to one enclosure to greatly reduce the size of the speaker and the cost of it and to mend the inconvenience of wiring, so that it owns greater mobility than the three cabinet design and achieve the goal of enjoying the deep bass sound on the go.

The prior art also discloses a modified enclosure structure which improves the sound effects. Such as Taiwan patent M307923, its modified enclosure structure improves the output sound effect of the sound signals by separating the treble part (high-frequency signal) from bass part (low-frequency signal), connecting the treble part to tweeter (high-frequency speaker) with treble signal line and bass part to woofer (low-frequency speaker) with bass signal line to make the treble sound smoother and bass sound more powerful. By the modification of the structure of the speaker, we may effectively improve the sound effect of the output sound signal. The modified speaker may output the left and right channel simultaneously, or output the sound signals from different sound sources.

The Taiwan patent M326304 has a built-in enclosure structure to reduce the enclosure size and the cost. However, the built-in enclosure has the natural defects that make the low-frequency effect worse.

In addition, the enclosure structure of Taiwan patent M307923 separates the sound source to the treble part and bass part and outputs to the tweeter and woofer respectively to enhance the sound effect of the sound signal, but raising the enclosure volume and cost in contrast.

In the light of this, what is required is a kind of enclosure structure technology which may reduce the size and get a better effect at low frequency, simultaneously.

### SUMMARY OF THE INVENTION

Based on the above discussion, one of the aspects of the present invention is to provide a kind of structure of a sealed type miniature speaker system.

Another aspect of the present invention is to provide a display containing the above structure of speaker.

The further object of the present invention is to improve the low-frequency effect of the enclosed type speaker by a plurality of passive radiators.

The invention discloses a structure of a sealed type miniature speaker which includes an enclosure; a speaker unit within the enclosure which its diaphragm is placed on the first side of the enclosure; a first passive radiator placed on the first side of the enclosure; and a second passive radiator placed on a second side of the enclosure, wherein the second side corresponds to the first side so that the first passive radiator and the second passive radiator may buffer the sound pressure generated by the speaker unit within the enclosure.

The invention also discloses a kind of liquid crystal display (LCD) comprising a display unit; a control unit coupled to the display unit to control the operation of the LCD; and a speaker coupled to the control unit, wherein the speaker includes a speaker unit placed within the enclosure and its diaphragm is on the first side of the enclosure; a first passive radiator placed on the first side of the enclosure unit; a second passive radiator placed on the second side of the enclosure, wherein the second side corresponds to the first side so that the first passive radiator and the second radiator may buffer the sound pressure generated from the enclosure.

The invention also discloses a display which includes a display unit; a control unit coupled to the display unit to control the operation of the display; and a speaker coupled to the control unit, wherein the speaker includes a speaker unit placed within the enclosure and its diaphragm is placed on a first side of the enclosure; a first passive radiator placed on the first side of the enclosure unit; a second passive radiator placed on a second side of the enclosure, wherein the second side is the back side of the first side, so that the first passive radiator and the second passive radiator may buffer the sound pressure generated from the enclosure unit.

The structure of the sealed type miniature speaker of the invention uses a plurality of passive radiators. The passive radiators are placed on the source side of the enclosure and the back side of it to increase the damping effect within the enclosure, to buffer the sound pressure within the enclosure, to reduce the vibration of the enclosure caused by the sound of speaker unit, and to improve the low-frequency effect effectively.

### BRIEF DESCRIPTION OF THE DRAWINGS

FIG. 1 illustrates the three-dimensional diagram of the sealed type miniature speaker according to the preferred embodiment of the present invention.

FIG. 2 illustrates the three-dimensional diagram of the back side of the sealed type miniature speaker according to the preferred embodiment of the present invention.

FIG. 3 illustrates the cross-sectional diagram of the sealed type miniature speaker according to the preferred embodiment of the present invention.

FIG. 4 illustrates the cross-sectional diagram of the sealed type miniature speaker according to the preferred embodiment of the present invention.

FIG. 5 illustrates an embodiment of the invention of a sealed type miniature speaker placed within a LCD.

### DESCRIPTION OF THE PREFERRED EMBODIMENT

The invention will be described and illustrated by the combination of embodiments and the following figures. One skilled in the art will appreciate that an embodiment is an implementation or example of the invention used to describe but not to limit. Furthermore, in addition to the mentioned embodiments, the invention may widely apply to other embodiments and not limited to any embodiments. Accordingly, it is the following claims, including any amendments thereto, and not the above description, that define the scope of the invention.

Reference in the specification to “One embodiment” or “an embodiment” means that a particular feature, structure, or characteristics described in connection with the embodiments is included in at least one embodiment. Thus, the various appearances of “in one embodiment” or “in an embodiment” are not necessarily all referring to the same embodiments. Furthermore, the particular feature, structure, or characteristics may be combined with one or more embodiments via any appropriate ways.

The present invention discloses a structure of enclosure (or sealed) type miniature speakers adapted within a display device such as liquid crystal display television (LCD TV), plasma display panel television (PDP TV), or other equivalent electronic devices to perform the functions. The passive radiators are arranged on the front side panel (or surface) of the enclosure of the speaker and the corresponding position of the back side panel (or surface) to reduce the vibration of the enclosure when the speaker unit is performed, thereby effectively improving the low-frequency effect.

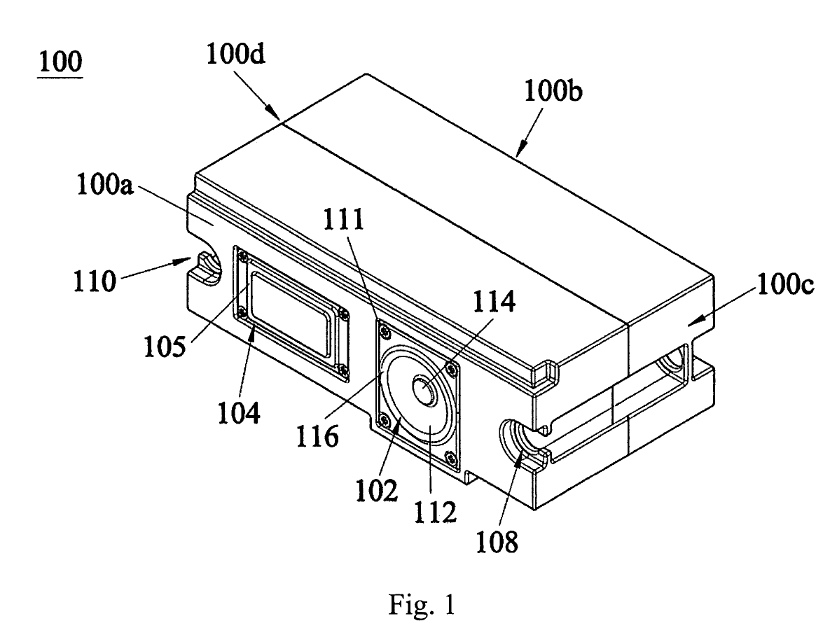

FIG. 1, according to the embodiments of the invention, is a three-dimensional diagram of sealed miniature speaker 100. The enclosure of the speaker 100 comprises four sides surface which is indicated by 100a, 100b, 100c, and 100d. The enclosure is similar but not limit to rectangle form, and any appropriate forms such as circle, ellipse, square, polygon, or irregular forms may be applied to the present invention. Because the sound waves are in sine wave form, and therefore the length of enclosure 100 of the speaker is a quarter of the sound wavelength of the natural resonant frequency generated by the speaker unit.

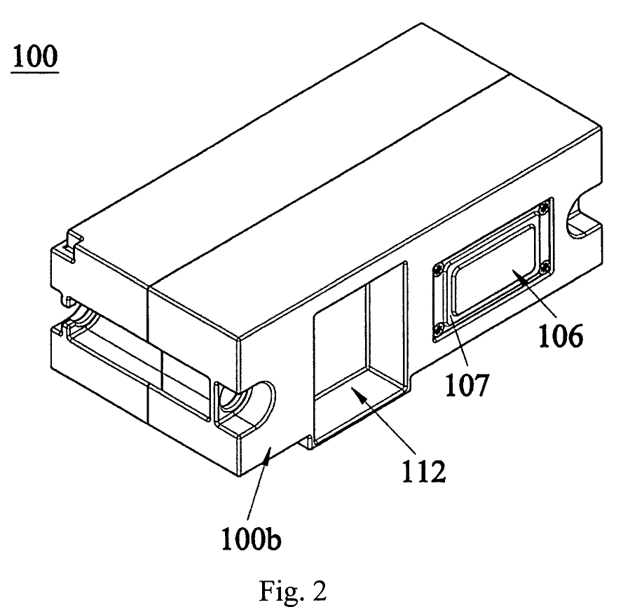

Speaker 100 includes a speaker unit 102, a first passive radiator 104, and a second passive radiator 106. Speaker unit 102 and first passive radiator 104 are together placed on the first side 100a of the enclosure of speaker 100. Second passive radiator 106 is placed on the second side 100b of the enclosure, and its position is placed corresponding to first passive radiator 104, as FIG. 2. Mass component 105 is fixed on first passive radiator 104 to adjust the mass of first passive radiator 104. In general, the material of mass component 105 is metal or iron. In contrast, there is also mass component 107 on second passive radiator 106 to adjust its mass.

Speaker unit 102 is in lieu of a base unit 111 which is mounted on first side 100a by screws or retainers. Diaphragm 112 is used to vibrate for generating sound waves and spread them to the air. Speaker unit 102 generates high or low frequencies according to the frequency of diaphragm 112. As the same material, the bigger the size of diaphragm is, the better response of low-frequency is obtained. In one embodiment, the material of the diaphragm 112 includes paper (mixtures of paper and glasses fiber), polypropylene (PP), Keppler, aluminum, ceramics, silk, titanium, beryllium, or a combination thereof. Dust cap 114 forms on the diaphragm 112. Surround 116 is joined with diaphragm 112. The material of surround 116 includes sponge, rubber, fabric, or a combination thereof.

Installation holes 108 and 110 are set on the sides 100c and 100d of the enclosure for convenience of installing the enclosure to a LCD TV or other similar electronic devices such as computer monitor or PDP TV. The second side 100b of the enclosure may contain an aperture 112 to set the internal circuits. For example, the circuits for transforming the external power supply to the usable power for the internal circuits of the enclosure; preliminary sound amplifying circuit; and the power amplifier to amplify the power of sound signal to drive speaker unit 102. Furthermore, the internal circuit of the enclosure also includes sorting circuit to separate the sound signal from high-frequency signal to low-frequency signal, and they will be sent to the treble unit and bass unit of the speaker unit, respectively. The circuit may also be placed outside the enclosure, but not limited to the place within the enclosure. The layout of the circuit in the embodiment is only for illustration but not to limit. Any appropriate layout may apply to the structure of the invention.

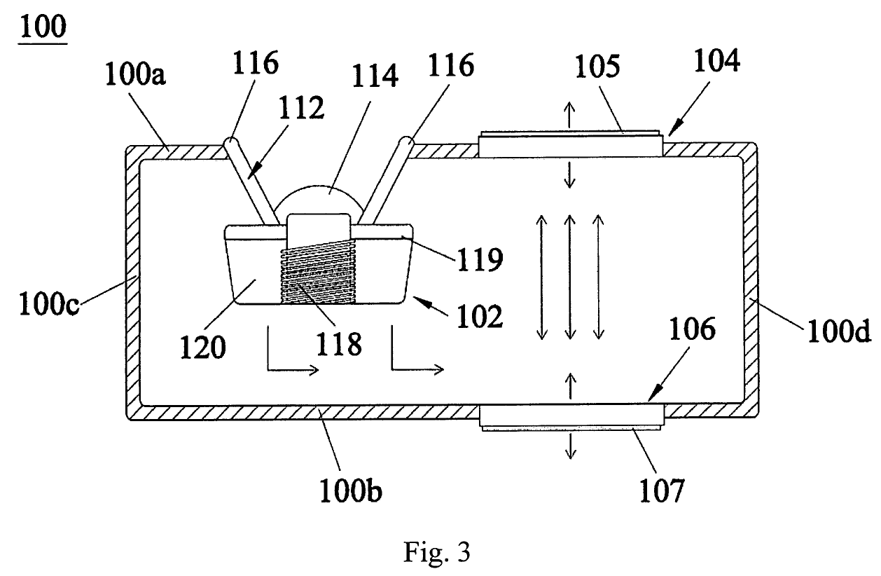

FIG. 3, according to the embodiment of the invention, is the cross-sectional diagram of speaker 100 of the invention. Speaker unit 102 is placed on the first side 100a of the enclosure of speaker 100 and it is close to first passive radiator 104. Speaker unit 102 includes diaphragm 112, dust cap 114, surround 116, coil 118, magnet 120, and other components.

Diaphragm 112 is formed on the base unit 119 of the speaker unit 102 for vibrating to generate sound waves and spread them to the air. Dust cap 114 is placed between the two lateral diaphragms 112. Surround 116 is joined with diaphragm 112. Coil 118 is usually performed as enameled wire and wound as a coil, and the coil will generate magnetism to attract or to repel magnet 120 when applying current. This will make diaphragm vibrate to generate sound waves. The winding direction of coil 118 may affect the sound signal and the phase of reproductive sound, the line aperture and inductive reactance of coil 118 may affect the transition rate and acceptable maximum power of speaker unit 102, and the line length may affect the impedance of speaker unit 102.

First passive radiator 104 is formed on the first side 100a and adjacent to speaker unit 102. In general, the material of first passive radiator 104 is rubber for the ease of generating vibration. First passive radiator 104 is used to improve the low-frequency effect. When speaker unit 102 generates low-frequency vibrations, the air within the enclosure generates sound pressure to get first passive radiator 104 vibrating and to extend the low-frequency part.

Second passive radiator 106 is placed on the second side 100b of the enclosure, and its position is corresponding to first passive radiator 104. First passive radiator 104 and second passive radiator 106 both have the same resonant frequency. The important technical feature of the invention is to increase a second passive radiator 106, and it is placed on the second side 100b corresponding to the position of first passive radiator 104. Second passive radiator 106 may further extend low-frequency part of the enclosure. When speaker 102 vibrates to sound, there will be corresponding vibrations within the enclosure. The sound pressure within the enclosure pushes first passive radiator 104 and second passive radiator 106 via air and make the interior of the enclosure continuously expand or contract as the arrow illustrated. Via the two elastic radiator 104 and 106, the vibration within the enclosure may be buffered and the low-frequency part may be expanded effectively, so that a better low-frequency effect may be obtained. In some embodiments, sound absorbing materials may also be added within the enclosure.

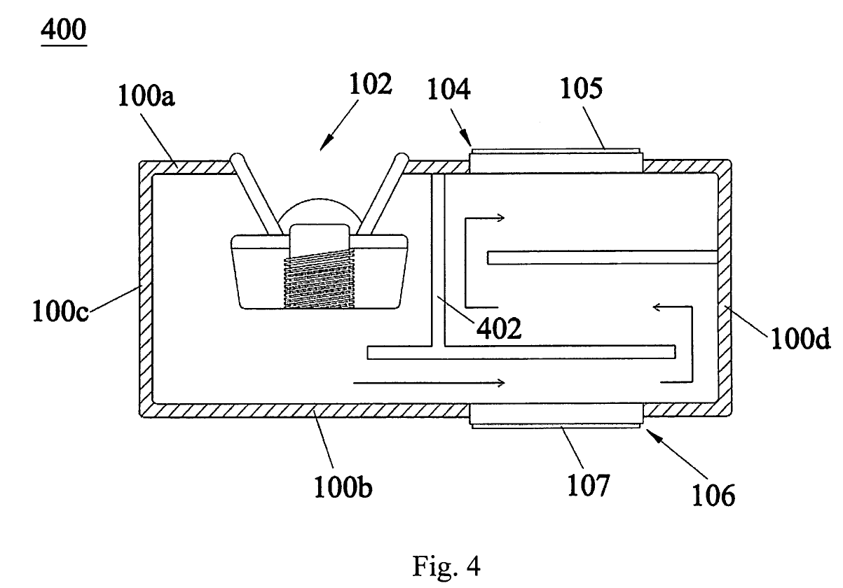

FIG. 4, according to the embodiments, is the cross-sectional diagram of sealed miniature speaker 400 of the invention. Part of the components of speaker 400 have the same structure of the speaker in FIG. 3, so there is no more description for that. The interior of speaker 400 placed partition plates 402 to form loop pathways and to increase the distance of the vibration pathway within the enclosure. Via the partition plates 402, the interior of the enclosure is partitioned into loop pathways. The sound waves generated by such speaker unit 102 may progress along the loop pathway and increase the damping effect within the enclosure to release the sound pressure within the enclosure with a lower rate.

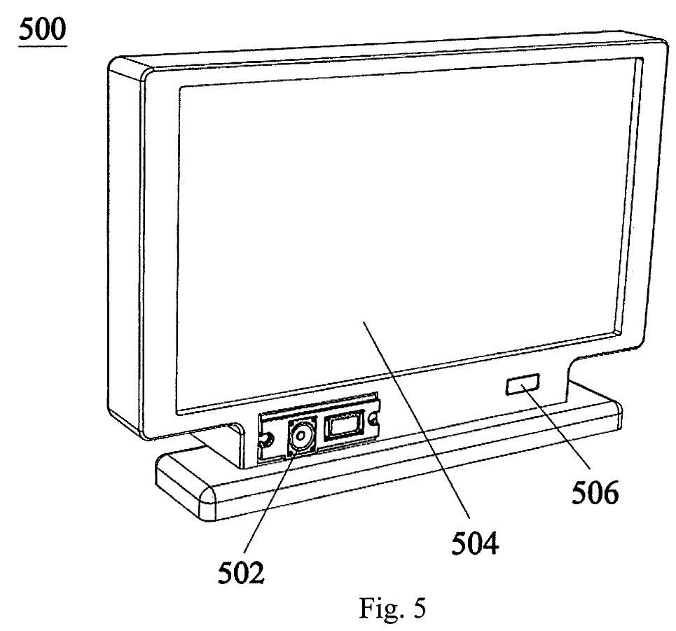

FIG. 5 is an implementation of an embodiment, it shows the sealed miniature speaker 502 of the present invention placed within the LCD 500. LCD 500 includes display unit 504 and speaker 502. LCD 500 contains control unit 506 to control the operation of LCD 500. In one embodiment, display 500 may further include LCD TV, PDP TV, or other similar display devices. Furthermore, the built-in speaker 502 within LCD 500 may be the enclosure illustrated in FIG. 1, FIG. 2, FIG. 3, and FIG. 4. However, it is not to limit the invention. According to the same principle, the invention may also apply to the computer monitor display.

In one embodiment, the enclosure of speaker 502 of the present invention may be combined with the body of LCD 500. The enclosure of speaker 502 of the invention may be built-in within the body of display 500, and inserting other components within the speaker 502 to form speaker 502. The above said enclosure need not other specific materials be prepared, but sharing the body with display 500. The structure of the above said enclosure is designed when designing the body of display 500, and being made with the body of display 500 simultaneously. So that the material of the body of the enclosure may be the same with the body of the LCD, and the body of the enclosure and the body of the LCD may be integrated as a whole.

Embodiments of the invention are illustrated by way of example, and not by way of limitation. The scope of the present invention should be determined by the claims below. One skilled in the art may make further modifications and adaptations without departing from the basic scope of the present invention. Thus the modifications and adaptations are belonging to the spirit of the teaching here and should be included among the following claims.

What is claimed is:

1. A sealed type miniature speaker, comprising:
an enclosure;
a speaker unit placed within said enclosure, and a diaphragm of said speaker unit placed on a first side of said enclosure;
a first passive radiator placed on said first side of said enclosure; and
a second passive radiator placed on a second side of the enclosure; wherein said second side corresponds to said first side, and said sound pressure generated by said speaker unit in said enclosure is buffered by said first passive radiator and said second passive radiator.

2. The sealed type miniature speaker of claim 1, wherein said first passive radiator contains a first mass component formed on said first passive radiator to adjust said mass of said first passive radiator, and said second passive radiator contains a second mass component formed on said second passive radiator to adjust said mass of said second passive component.

3. The sealed type miniature speaker of claim 1, wherein said materials of said diaphragm include paper, polypropylene(PP), Keppler, aluminum, ceramics, silk, titanium, beryllium or the combination thereof.

4. The sealed type miniature speaker of claim 1, wherein said speaker unit contains a dust cap formed between said diaphragms and a surround joined said diaphragm, wherein said materials of said surround include sponge, rubber, fabric, or the combination thereof.

5. The sealed type miniature speaker of claim 1, wherein said length of said enclosure is a quarter of the length of said sound wavelength of said natural resonant frequency generated by said speaker unit; said first passive radiator and said second passive radiator have said same resonant frequency.

6. The sealed type miniature speaker of claim 1, further comprising a partition plate placed within said enclosure to increase said loop pathways of said sound waves of said speaker unit, and to generate said damping effect inside said enclosure.

7. A liquid crystal display (LCD), comprising:
a display unit;
a control unit coupled with said display unit to control said operation of said LCD; and
a speaker coupled with said control unit, wherein said speaker contains:
a speaker unit placed within said enclosure of said speaker, and said diaphragm of said enclosure unit is placed on said first side of said enclosure;
a first passive radiator placed on said first side of said enclosure; and
a second passive radiator placed on a second side of said enclosure, where said second side corresponds to said first side, and said sound pressure generated from said enclosure is buffered by said first passive radiator and said second passive radiator.

8. The liquid crystal display of claim 7, wherein said first passive radiator has a first mass component formed on it to adjust its mass, and said second passive radiator has a second mass component formed on it to adjust its mass.

9. The liquid crystal display of claim 7, wherein said materials of said diaphragm include paper, polypropylene (PP), Keppler, aluminum, ceramics, silk, titanium, beryllium, or the combination thereof.

10. The liquid crystal display of claim 7, wherein said speaker unit has a dust cap formed between said diaphragms and a surround joined said diaphragm, wherein said materials of said surround include sponge, rubber, fabric, or a combination thereof.

11. The liquid crystal display of claim 7, wherein said length of said enclosure is a quarter of said length of said sound wavelength of said natural resonant frequency generated by said speaker unit; said first passive radiator and said second passive radiator have the same resonant frequency.

12. The liquid crystal display of claim 7, further comprising a partition plate placed within said enclosure to increase said loop pathways of said sound waves of said speaker unit, and to generate said damping effect within said enclosure.

13. A display, comprising:
a display unit;
a control unit coupled with said display unit to control said operation of said display; and
a speaker coupled with said control unit, wherein said speaker contains:
a speaker unit placed within said enclosure of said speaker, and said diaphragm of said speaker unit is placed on said first side of said enclosure;
a passive radiator placed on said first side of said enclosure; and
a second passive radiator placed on a second side of said enclosure, wherein said second side is the back side of said first side, and said sound pressure generated from said enclosure is buffered by said first passive radiator and said second passive radiator.

14. The display of claim 13, wherein said first passive radiator has a first mass component forms on it to adjust its mass, and said second passive radiator has a second mass component forms on it to adjust its mass.

15. The display of claim 13, wherein said materials of said diaphragm include paper, polypropylene(PP), Keppler, aluminum, ceramics, silk, titanium, beryllium, or the combination thereof.

16. The display of claim 13, wherein said speaker unit has a dust cap formed between said diaphragms and a surround joined said diaphragm, wherein said materials of said surround include sponge, rubber, fabric, or the combination thereof.

17. The display of claim 13, wherein said length of said enclosure is a quarter of said sound wavelength of said natural resonant frequency generated by said speaker unit; said first passive radiator and said second passive radiator have the same resonant frequency.

18. The display of claim 13, further comprising a partition plate placed within said enclosure to increase said loop pathways of said sound waves generated by said speaker unit, so that generating said damping effect within said enclosure.

19. The display of claim 13, wherein said body structure of said enclosure is designed when designing said body structure of said display, and being made with said body of display simultaneously, so that said material of said body of said enclosure may be the same with said body of said display, and said body of said enclosure and said body of said display may be integrated as a whole.

20. The display of claim 13, wherein said display includes liquid crystal display television (LCD TV) or plasma display panel television (PDP TV).
